(19) United States
(12) Patent Application Publication
(10) Pub. No.: US 2024/0141891 A1
(43) Pub. Date: May 2, 2024

(54) DEVICES, SYSTEMS, AND METHODS FOR A DIAPHRAGM PUMP

(71) Applicant: Repligen Corporation, Waltham, MA (US)

(72) Inventor: Rudolf Pavlik, Huntington Beach, CA (US)

(73) Assignee: Repligen Corporation, Waltham, MA (US)

(21) Appl. No.: 18/270,910

(22) PCT Filed: Jan. 11, 2022
(86) PCT No.: PCT/US22/12011

§ 371 Date: Jul. 5, 2023

Related U.S. Application Data
(60) Provisional application No. 63/136,483, filed on Jan. 12, 2021.

(51) Int. Cl. F04B 53/20; F04B 43/02; F04B 45/04

(52) U.S. Cl. CPC F04B 53/20; F04B 43/02; F04B 45/04

(57) ABSTRACT

The present disclosure relates to diaphragm pumps with one or more filters, e.g., tangential flow filters, membranes, and ultrafiltration membranes, for various applications, including, e.g., bioprocessing and pharmaceutical applications, systems employing such filters, and methods of filtration using the same. In an aspect, a pump for alternating tangential flow filtration may include a diaphragm. A housing may contain the diaphragm. The housing may have a first end open to a retentate channel of a first membrane. A magnetic member may be coupled to the diaphragm. An electromagnetic field generator may be disposed about the magnetic member.

### CROSS-REFERENCE TO RELATED APPLICATION

The present application claims the benefit of priority under Article 8 of the Patent Cooperation Treaty and 35 U.S.C. § 119s to U.S. Provisional Application 63/136,483, filed Jan. 12, 2021, which application is hereby incorporated herein by reference in its entirety for all purposes.

### FIELD

The present disclosure relates to diaphragm pumps with one or more filters, e.g., tangential flow filters, membranes, and ultrafiltration membranes, for various applications, including, e.g., bioprocessing and pharmaceutical applications, systems employing such filters, and methods of filtration using the same.

### BACKGROUND

Diaphragm pumps may be used to move media into, along, and/or adjacent a filter. Diaphragm actuation may include changing/alternating positive and negative fluid pressure (e.g., air, a vacuum, a partial vacuum, or a combination thereof) on a side of the diaphragm. Managing diaphragm actuation in this way may be problematic due to inconsistent fluid pressure, mismanagement of fluid compressibility, contamination across the diaphragm, and/or non-linear or unpredictable diaphragm stroke actuation that may compromise filtration performance.

It is with respect to these considerations that the devices, systems, and methods of the present disclosure may be useful.

### SUMMARY

Filtration processing systems using a pump with alternating tangential flow may be installed in fluid communication with or without upstream and/or downstream processes. In an aspect of an embodiment described herein, a pump for alternating tangential flow filtration may comprise a pump for alternating tangential flow filtration may include a diaphragm. A housing may contain the diaphragm. The housing may have a first end open to a retentate channel of a first membrane. A magnetic member may be coupled to the diaphragm. An electromagnetic field generator may be disposed about the magnetic member.

In various embodiments, the magnetic member may be overmolded within the diaphragm. An elongate member coupling the magnetic member to the diaphragm. The housing may comprise a second end open to a 0.2 μm filter. The housing may comprise a second end open to a retentate channel of a second membrane. The electromagnetic field generator may be cylindrically disposed about the housing. The electromagnetic field generator may be cylindrically disposed about the diaphragm. The diaphragm may comprise a wall having a first thickness. The wall may comprise at least one concentric ring comprising a second thickness different than the first thickness. The diaphragm may further comprise a perimeter portion comprising a first durometer. A mid-portion comprising a second durometer may be less than the first durometer. A central portion may comprise the first durometer. The mid-portion may be overmolded between the perimeter portion and the central portion. The diaphragm may comprise a pre-formed sinusoid. The diaphragm may comprise a wall having a thickness tapering from a thicker central portion to a thinner perimeter portion. The diaphragm may further comprise a sensor in fluid communication with the retentate channel.

In another aspect of an embodiment described herein, a pump for alternating tangential flow filtration may comprise a diaphragm comprising a perimeter portion and a central portion. A magnetic member may be disposed within the central portion of the diaphragm. A housing may contain the diaphragm. The housing may have a first end open to a retentate channel of a first membrane. An electromagnetic field generator may be disposed about the housing. The electromagnetic field generator may comprise an inner diameter substantially matching an outer diameter of the housing.

In various embodiments, the magnetic member may be overmolded within the diaphragm. A linear encoder may be along a height of the electromagnetic field generator. The housing may further comprise a second end open to a retentate channel of a second membrane. The membrane may be an alternating tangential flow membrane.

In another aspect of an embodiment described herein, a pump for alternating tangential flow filtration may comprise a diaphragm comprising a perimeter portion and a central portion. An elongate member may have a first end coupled to the central portion of the diaphragm and a second end. A magnetic member may be coupled to the second end of the elongate member. A housing may contain the diaphragm, the elongate member and the magnetic member. The housing may comprise a first end open to a retentate channel of a membrane and a second end comprising a filter. An electromagnetic field generator may reversibly contain the second end of the housing. The electromagnetic field generator may comprise an inner diameter substantially matching an outer diameter of the second end of the housing. The second end of the housing may comprise an extension portion containing the magnetic member. The extension portion may have a height substantially matching a height of a displacement of the diaphragm between a first position and a second position. The membrane may be an alternating tangential flow membrane.

### BRIEF DESCRIPTION OF THE DRAWINGS

The above and other aspects of the present disclosure will be more apparent from the following detailed description, presented in conjunction with the following drawings wherein:

FIG. 1 illustrates a partial cross-section of a pump including a magnetic member overmolded within a diaphragm, in accordance with an embodiment of the present disclosure.

FIG. 2 illustrates a partial cross-section of a pump including an elongate member coupling a magnetic member to a diaphragm, in accordance with an embodiment of the present disclosure.

FIG. 3 illustrates a partial cross-section of a pump including a magnetic member overmolded within a diaphragm between two filters, in accordance with an embodiment of the present disclosure.

FIG. 4A illustrates a cross-section of a diaphragm including concentric rings of varying thickness, in accordance with an embodiment of the present disclosure.

FIG. 4B illustrates a cross-section of a diaphragm including concentric rings of varying thickness, in accordance with an embodiment of the present disclosure.

FIGS. 5A and 5B illustrate a cross-section of a diaphragm including a perimeter portion, a mid-portion, and a central portion, in accordance with an embodiment of the present disclosure.

FIG. 6 illustrates a cross-section of a diaphragm including a pre-formed sinusoid, in accordance with an embodiment of the present disclosure.

FIG. 7 illustrates a cross-section of a diaphragm including a wall having a thickness tapering from a thicker central portion to a thinner perimeter portion, in accordance with an embodiment of the present disclosure.

### DETAILED DESCRIPTION

### Overview

Creating an end product may require processing a media to a desirable concentrate by reciprocating the fluid through and/or along a filter. Tangential flow filtration devices using membranes, e.g., ultrafiltration membranes, may be used in the biological pharmaceuticals industry to concentrate and/or diafiltrate process streams. Operating a diaphragm pump for media processing may be used to move media into, along, and/or adjacent a filter. Diaphragm actuation may include changing/alternating positive and negative fluid pressure on a side of the diaphragm. Managing diaphragm actuation in this way may be problematic due to inconsistent fluid pressure, mismanagement of fluid compressibility, contamination across the diaphragm from overpressurizing, and/or non-linear or unpredictable diaphragm stroke movement that may compromise filtration performance.

Therefore, there is a need in the bioprocessing industry for alternative diaphragm pump actuation, e.g., for use in an alternating tangential flow system for continuous processing. Exemplary embodiments discussed herein include parameters and operating variables that address these needs.

### Exemplary Embodiments

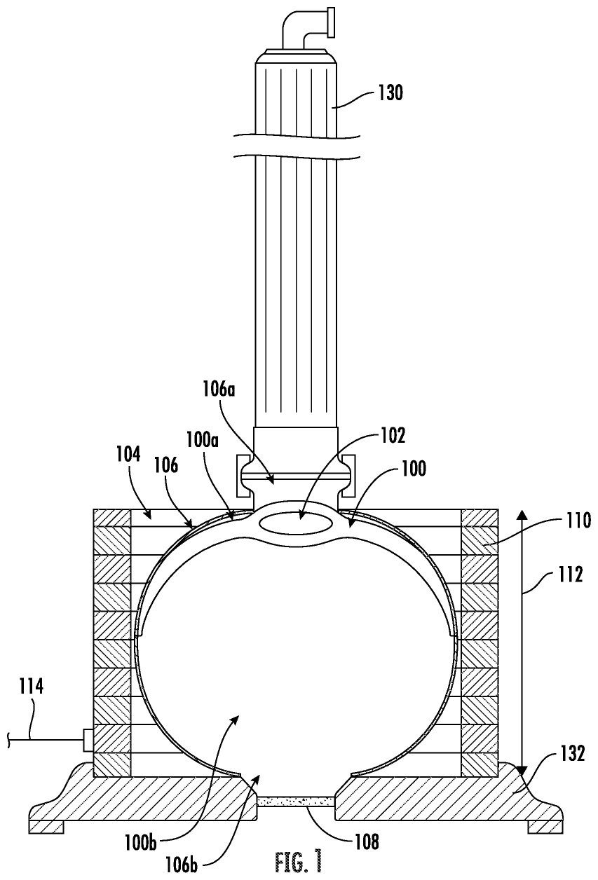

Referring to FIG. 1, a partial cross-section of a pump 104 coupled with a filter 130 is illustrated, according to an exemplary embodiment of the present disclosure. The pump 104 includes a housing 106 with a first end 106a open to a retentate channel of, e.g., a membrane, of the filter 130. A diaphragm 100 is contained within the housing 106 that is configured to actuate and flow a media from a first side 100a of the diaphragm 100 into and out of the filter 130. The diaphragm 100 includes a magnetic member 102 coupled to the diaphragm 100, e.g., via overmolding. The pump 104 includes an electromagnetic field generator 110 (e.g., an axial or linear actuator or stator) disposed about the housing 106 (e.g., cylindrically about the housing 106). The generator 110 is configured to generate a magnetic field along its length, i.e., towards and away from the first end 106a and a second end 106b substantially in the directions of the arrows 112. The magnetic member 102 is susceptible to the magnetic field generated by the generator 110 such that its position moves with the magnetic field along the generator 110, i.e., substantially in the directions of the arrows 112. Because the magnetic member 102 is coupled to the diaphragm 100, movement of the magnetic member 102 also moves the diaphragm 100. For example, the magnetic member 102 and the diaphragm 100 may be actuated towards and away from the first end 106a by the generator 110. The housing 106 includes a second end 106b in fluid communication with a second side 100b of the diaphragm 100 within the housing 106. As the diaphragm 100 is actuated, a fluid within the second side 100b may be compressed and/or flowed out of or be drawn in through the second end 106b by the diaphragm 100. The generator 110 is operated by a controller communicatively connected by an electrical connection 114. The second end 106b includes a porous filter 108 (e.g., an about 0.2 μm porous filter, or the like) configured to substantially prevent undesirable particulates from entering (i.e., being drawn into) the second side 100b, e.g., as the diaphragm 100 is actuated toward the first end 106a. A stand 132 about the generator 110 may assist with containing and/or stabilizing the generator 110 and/or the housing 106.

In various embodiments described herein, an electromagnetic field generator (e.g., an axial or linear actuator or stator) may include stacked layers that may be sequentially activated in layers. A generator may be electrically activated to generate a controlled layered electromagnetic field with which to advance a magnetic member. The thickness of each layer may vary to affect a resolution of generator actuation. Activation time, deactivation time, activated layer switching time, power, and/or intensity may be controlled by a controller as described herein. For example, an amount of time taken to switch activated layers may dictate a flow rate and/or force to flow one or more fluids. For example, sequential activation may require additional force in response to an increased viscosity of a fluid.

In various embodiments described herein, a controller and/or one or more sensors may communicate with and/or read information from a magnetic field generator by one or more electrical/physical connections or signals. For example, a controller may instruct a generator to generate a magnetic field along a length of the generator at specific speeds, frequencies, lengths, forces, or the like. One or more sensors may read characteristics of a field generated and/or a magnetic member (and therefore a diaphragm) such as a position, speed, direction, frequency, force, flow confirmation, viscosity, stroke length confirmation, or the like. Additionally, or in the alternative, one or more sensors may be coupled to a magnetic member and/or a diaphragm. A controller or a user may respond to sensor readings to adjust the field generated, e.g., adjusting the linear velocity of a field along a generator in response to a viscosity reading from a sensor, actuating a diaphragm in response to a position reading of a magnetic member from a linear encoder coinciding with a stroke completion for a change in a direction of the magnetic field, or the like.

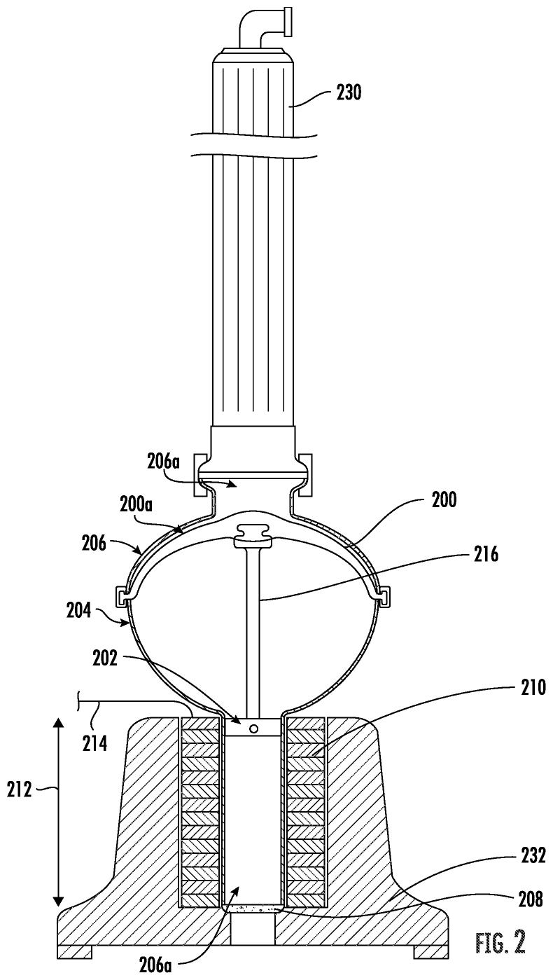

Referring to FIG. 2, a partial cross-section of a pump 204 coupled with a filter 230 is illustrated, according to an exemplary embodiment of the present disclosure. The pump 204 includes a housing 206 with a first end 206a open to a retentate channel of, e.g., a membrane, of the filter 230. A diaphragm 200 is contained within the housing 206 that is configured to actuate and flow a media from a first side 200a of the diaphragm 200 within the housing 206 into and out of the filter 230. An elongate member 216 is coupled to the diaphragm 200 at one end (e.g., via overmolding) and the elongate member 216 is coupled to a magnetic member 202 at the opposing end. The pump 204 includes an electromagnetic field generator 210 (e.g., an axial or linear actuator or stator) disposed about a second end 206b of the housing 206 (e.g., cylindrically about the housing 206). The generator 210 is configured to generate a magnetic field along its length, i.e., towards and away from the first end 206a substantially in the directions of the arrows 212. The magnetic member 202 is susceptible to the magnetic field generated by the generator 210 such that its position moves along with the magnetic field along the generator 210 (i.e., substantially in the directions of the arrows 212). Because the magnetic member 202 is coupled to the diaphragm 200 via the elongate member 216, movement of the magnetic member 202 also moves the diaphragm 200. For example, the magnetic member 202 and the diaphragm 200 may be actuated towards the first and second ends 206a, 206b by the generator 210. The generator 210 is operated by a controller communicatively connected by an electrical connection 214. As the magnetic member 202 and the diaphragm 200 are actuated by the generator 210, a fluid within the second end 206b may be compressed and/or flow out of or be drawn in through the second end 206b by the magnetic member 202. The second end 206b includes a porous filter 208 (e.g., an about 0.2 μm porous filter, or the like) configured to substantially prevent undesirable particulates from entering (i.e., being drawn into) the second end 206b, e.g., as the diaphragm 200 is actuated toward the first end 206a. The second end 206b of the housing 206 includes a portion having a smaller outer diameter than a remainder of the housing 206 such that the generator 210 disposed about second end 206b is smaller than, e.g., the generator 110 of the embodiment of FIG. 1. Furthermore, various pump housings 206 of alternative volumes and sizes may include substantially similar second ends 206b such that the housings 206 may be interchangeable with the same generator 210 because the generator 210 may be sized for a substantially similar sized second end 206b of the various pump housings 206. A stand 232 about the generator 210 may assist with holding and/or stabilizing the generator 210 and/or housing 206. Markings such as QR codes may be displayed on the stand 232, the generator 210, and/or the housing 206 to assist with tracking interchanging of housings 206 or to assist with adjusting the magnetic member 202 position or stroke length of the generator 210 to coincide with the housing 206. For example, insertion of the second end 206b into the generator 210 may automatically reset the stroke distance of the magnetic member 202 and the diaphragm 200 of the housing 206.

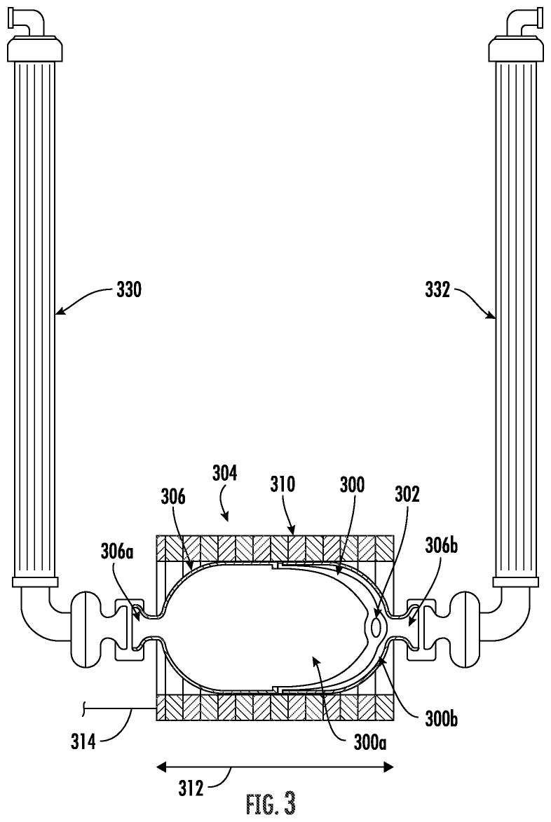

Referring to FIG. 3, a partial cross-section of a pump 304 between first and second filters 330, 332 is illustrated in accordance with an embodiment of the present disclosure. The pump 304 includes a housing 306 with a first end 306a open to a retentate channel of the first filter 330, and the housing 306 has a second end 306b open to a retentate channel of the second filter 332 (e.g., retentate channels of membranes of the first and second filters 330, 332). A diaphragm 300 is contained within the housing 306 that is configured to actuate and flow a first media from a first side 300a of the diaphragm 300 within the housing 306 into and out of the first filter 330 through the first end 306a, and a second media from a second side 300b of the diaphragm 300 within the housing 306 into and out of the second filter 332 through the second end 306b. The diaphragm 300 includes a magnetic member 302 coupled to the diaphragm 300, e.g., via overmolding. The pump 304 includes an electromagnetic field generator 310 (e.g., an axial or linear actuator or stator) disposed about the housing 306 (e.g., cylindrically about the housing 306). The generator 310 is configured to generate a magnetic field along its length, i.e., towards and away from the first end 306a and a second end 306b substantially in the directions of the arrows 312. The magnetic member 302 is susceptible to the magnetic field generated by the generator 310 such that its position moves with the magnetic field along the generator 310 (i.e., substantially in the directions of the arrows 312). Because the magnetic member 302 is coupled to the diaphragm 300, movement of the magnetic member 102 also moves the diaphragm 300. For example, the magnetic member 302 and the diaphragm 300 may be actuated towards the first and second ends 306a, 306b by the generator 310. Because there are first and second media for filtering on both sides 300a, 300b of the diaphragm 300, each stroke of the diaphragm 300 flows a media into one of the filters 330, 332 (e.g., compared to flowing media into the filter 130 substantially only during a stroke of the diaphragm 100 towards the first end 106a of FIG. 1). The generator 310 is operated by a controller communicatively connected by an electrical connection 314. Although the filters 330, 332 and pump 304 are illustrated in an orientation with substantial portions of the filters 330, 332 above the pump 304, other orientations are contemplated, e.g., a pump oriented vertically between two filters, a pump substantially above two filters, a combination thereof, or the like.

In various embodiments described herein, a pump may be actuated using a diaphragm. Such diaphragms may or may not include one or more features from one or more embodiments described herein. For example, a diaphragm may or may not include a magnetic member and/or may or may not include one or more concentric features described herein. As another example, a diaphragm may exclude a magnetic member or another member coupled to an elongate member or a magnetic member.

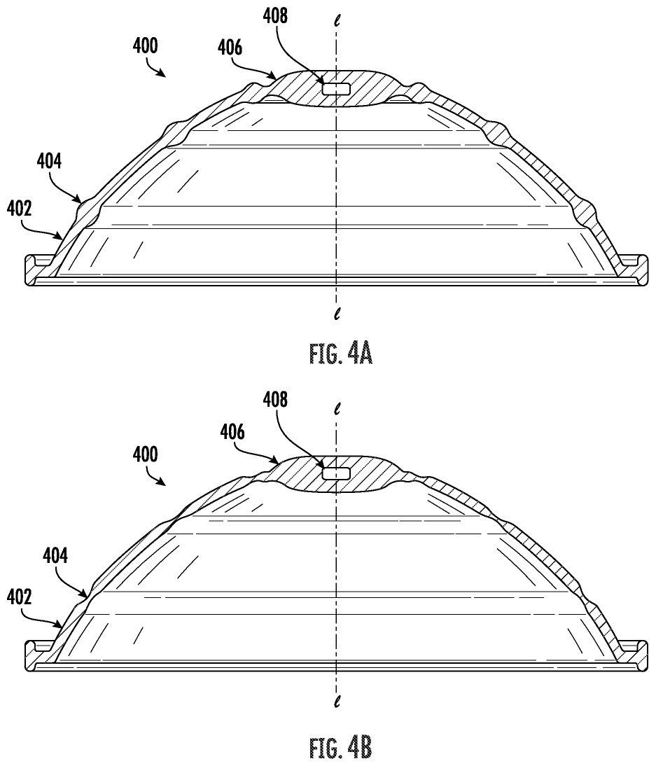

Referring to FIGS. 4A and 4B, cross-sections of diaphragms 400 including concentric features are illustrated, in accordance with embodiments of the present disclosure. The diaphragms 400 include a wall having a first thickness 402 and concentric rings 404 about an axis l having thicknesses different than that of the first thickness 402. In FIG. 4A, the rings 404 are thicker than the first thickness 402 and in FIG. 4B, the rings 404 are thinner than the first thickness 402. The concentric rings 404 may assist with uniform axial actuation and/or flexing of the diaphragm 400 along the axis €. For example, during a stroke of the diaphragm 400 of FIG. 4A, portions along the wall having the first thickness 402 may more easily flex than that of the thicker concentric rings 404 such that actuation/flexing transfers up to and thereafter through the thicker concentric rings 404 substantially simultaneously about the circumference of the concentric rings 404. As another example, during a stroke of the diaphragm 400 of FIG. 4B, the thinner concentric rings 404 may more easily flex than that of the portions along the wall having the first thickness 402 such that actuation/flexing transfers immediately to each of the thinner concentric rings 404 substantially simultaneously about the circumference of the concentric rings 404. A central portion 406 of each of the diaphragms 404 of FIGS. 4A and 4B may have a thickness larger than that of the first thickness 402. The thicker central portion 406 may withstand greater force than that of the remainder of the diaphragm 400 and contains a member 408 such as one or more sensors or magnetic members as described herein (e.g., through overmolding).

In various embodiments described herein, a pump may include a diaphragm that includes one or more concentric features. These concentric features may assist with uniform axial actuation/flexing of the diaphragm during operation such that the media being pumped may flow with consistent and/or predictable force and rate. Such uniform actuation/flexing may assist with diaphragm maintenance, reduce failure, and increase filtration performance.

In various embodiments described herein, filter components, pump components, housings, diaphragms, and other associated components may comprise any number of materials. Such materials may withstand temperature and pressure conditions of sterilization, e.g., in an autoclave, a steaming regiment, or gamma irradiation. Depending on use, however, filtration systems may also be constructed of materials that may be sterilized by gas or radiation. Furthermore, where sterility is not required, any number of materials may be used. Exemplary materials may include materials such as stainless steels, elastomers, or polymers. For example, medical grade silicone for flexible components and polycarbonate and/or polysulfonate for rigid components or the like. In various embodiments, single use components may be constructed of a gamma sterilization resistant material that is fully assembled and sterilized. Alternatively, components may be protected with an aseptic connector that can be offered for custom applications. Some pump components, e.g., a magnetic field generator, may be reusable while a remainder of the pump components may be single use.

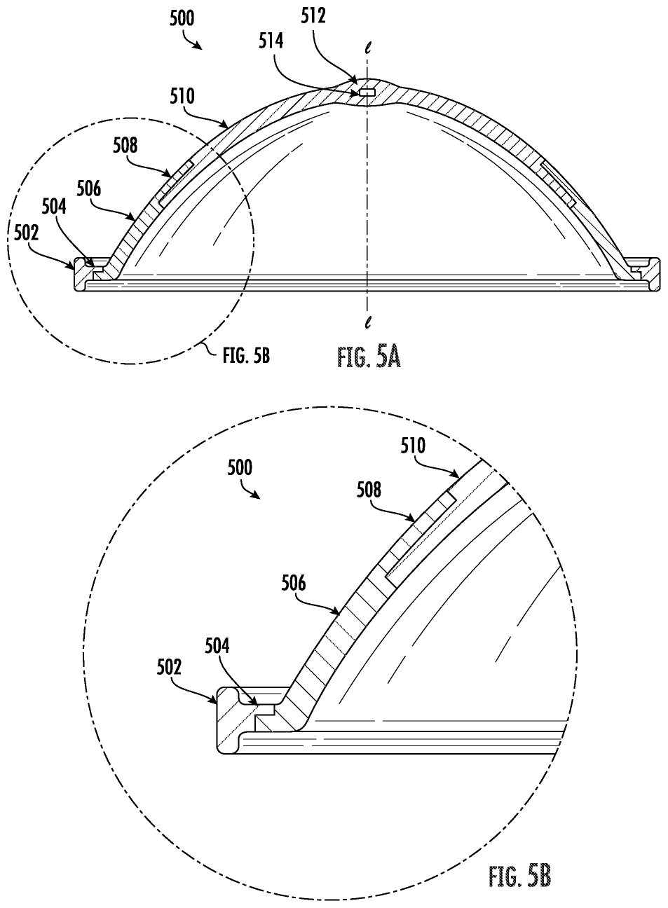

Referring to FIGS. 5A and 5B, a cross-section of a diaphragm 500 including concentric features is illustrated, in accordance with an embodiment of the present disclosure. The concentric features of the diaphragm 500 include a perimeter portion 502, a mid-portion 506, and a central portion 510. The perimeter portion 502 extends concentrically about a longitudinal axis € of the diaphragm 500 and is configured to be constrained by a housing as described herein. The perimeter portion 502 is made up of a material having a first durometer desirable with the housing (e.g., about Shore A 60 or the like) that may be less flexible than a remainder of the diaphragm 500. The mid portion 506 of the diaphragm 500 is adjacent to and concentrically within the perimeter portion 502. The mid portion 506 is configured to extend away from the perimeter portion 502 towards the longitudinal axis € and may be subject to more movement and/or flexing during actuation of the diaphragm 500 than the constrained perimeter portion 502. Therefore, the mid portion 506 is made up of a material having a second durometer less than that of the first durometer of the perimeter portion 502 (e.g., about Shore A 30 or the like). The perimeter portion 502 overlaps the mid portion 506 at a first overlap 504. The central portion 510 of the diaphragm 500 is adjacent to and concentrically within the mid portion 506. The central portion 510 is configured to extend away from the mid portion 506 such that it intersects the longitudinal axis l and may be subject to less flexing during actuation of the diaphragm 500 than the mid portion 506. Therefore, the central portion 510 is made up of a material having a third durometer more than that of the second durometer of the mid portion 506 (e.g., about Shore A 70 or the like). The mid portion 506 overlaps the central portion 510 at a second overlap 508. The first and second overlaps 504, 508 may be formed by various methods such as flowing, overmolding, adhesion, tacking, a combination thereof, or the like. Although the portions 502, 506, 510 are illustrated at the first and second overlapping portions 504 and 508 as overlapping each other in a particular way (e.g., the first overlap 504 with the perimeter portion 502 over the mid portion 506 and the second overlap 508 with the mid portion 506 over the central portion 510), one or more of the portions 502, 506, 510 may overlap another in a reverse fashion, one extending inside of another, two portions 502, 506, 510 adjacent without overlapping, and/or two portions 502, 506, 510 mixing or being flowed together. The central portion 510 includes an apex portion 512 that is thicker than a remainder of the central portion 510 that contains a member 514 such as one or more sensors or magnetic members as described herein (e.g., through overmolding).

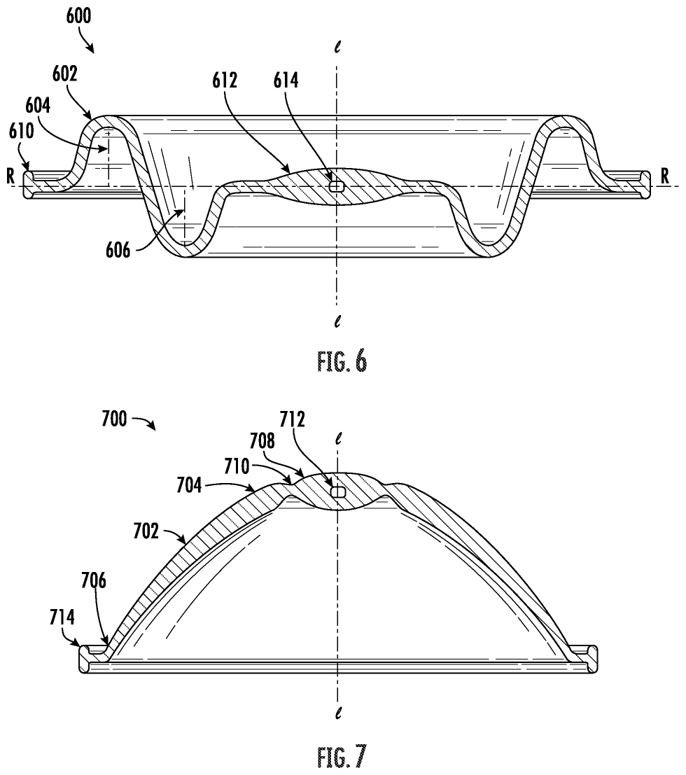

Referring to FIG. 6, a cross-section of a diaphragm 600 including a pre-formed sinusoid 602 concentric feature is illustrated, in accordance with an embodiment of the present disclosure. The pre-formed sinusoid 602 extends from a perimeter portion 610 of the diaphragm 600 toward a longitudinal axis l of the diaphragm 600. The sinusoid 602 extends to a crest at each of the first amplitude 604 and the second amplitude 606 that each extend from a radial axis R of the diaphragm 600. A wavelength of the sinusoid 602 ends adjacent a central portion 612. The central portion 612 has a thickness larger than that of the wall of the sinusoid 602 that may withstand greater force than that of the remainder of the diaphragm 600 and may contain a member 614 such as one or more sensors or magnetic members as described herein (e.g., through overmolding). Although the sinusoid 602 is illustrated with a particular waveform, alternative sinusoidal waveforms are contemplated. For example, the first and second amplitudes 604, 606 may be equal or non-equal, the wavelength may be between or extend outside of the perimeter 610 and/or the longitudinal axis, etc.

Referring to FIG. 7, a cross-section of a diaphragm 700 including a concentric feature is illustrated, in accordance with an embodiment of the present disclosure. The diaphragm 700 includes a wall 702 having a thickness at a thicker central end 704 towards a longitudinal axis l that tapers to a thinner perimeter end 706 away from the longitudinal axis 13 and adjacent a perimeter 714 of the diaphragm 700. As the diaphragm 700 is actuated, the diaphragm 700 may flex substantially uniformly along the wall 702 from the thinner perimeter end 706 toward the thicker central end 704 as it requires progressively more force to move/flex the wall 702 as the wall 702 thickens. An additional concentric feature of the diaphragm 700 is a channeled ring 710 that is concentric to the thicker central end 704 about the longitudinal axis 13. The channeled ring 710 has a wall thickness thinner than the central end 704 configured to more easily flex than the central end 740 such that concentric flexing and axial flexing of the actuated diaphragm 700 is encouraged. A central portion 708 coincident with the longitudinal axis l may be thicker than other portions of the diaphragm 700 such that it may withstand greater force than that of the remainder of the diaphragm 700 and contains a member 712 such as one or more sensors or magnetic members as described herein (e.g., through overmolding).

A pump of a system embodiment of the present disclosure may be a variety of pump types. For example, a diaphragm, a linear pump, a piston pump, a plunger pump, a gear pump, an axial-flow pump, a lobe pump, a pump-jet, a screw pump, a piezoelectric pump, a centrifugal pump, a combination thereof or the like.

A system herein may be standalone, may be upstream from and in fluid communication with another system, and/or may be downstream from and in fluid communication with another system. A flow rate of a feed line of a system may depend on the output of an upstream system. A flowrate of a retentate outlet may depend on the feed line of a downstream system.

In various embodiments, a method of alternating tangential flow may include feeding a fluid directly from a first fluid process into fluid communication with a membrane. The fluid may be reciprocated tangentially across a membrane. The fluid may be pumped directly from the membrane to a second fluid process. The second fluid process may include reciprocating the fluid tangentially across another membrane. The reciprocating step may be performed continuously, e.g., for more than 24 hours or the like.

Tangential flow filters in accordance with the present disclosure include tangential flow filters and membranes having pore sizes and depths that are suitable for excluding large particles (e.g., cells, micro-carriers, or other large particles), trapping intermediate-sized particles (e.g., cell debris, or other intermediate-sized particles), microparticles, molecules, and allowing small particles (e.g., soluble and insoluble cell metabolites and other products produced by cells including expressed proteins, viruses, virus like particles (VLPs), exosomes, lipids, DNA, molecules, or other small particles).

### CONCLUSION

The present disclosure is not limited to the particular embodiments described. The terminology used herein is for the purpose of describing particular embodiments only and is not intended to be limiting. Unless otherwise defined, all technical terms used herein have the same meaning as commonly understood by one of ordinary skill in the art to which the disclosure belongs.

As used herein, the term “diaphragm” may be understood by a person having ordinary skill in the art to be an elastic member for displacing fluid, a component of a pump, a pump, and/or used interchangeably with the term “diaphragm pump” depending on context. As used herein, the term “filter” may include one or more of a filter housing, a mesh, a membrane, or the like. As used herein, the term “fluid” may include a media and/or a fluid for processing or a fluid for manipulating a diaphragm of a pump depending on context.

Although embodiments of the present disclosure are described with specific reference to cultured mediums, including for use in bioprocessing, it should be appreciated that such systems and methods may be used in a variety of configurations of processing fluids, with a variety of instruments, and a variety of fluids.

As used herein, the singular forms “a,” “an,” and “the” are intended to include the plural forms as well, unless the context clearly indicates otherwise. The terms “comprises” and/or “comprising,” or “includes” and/or “including” when used herein, specify the presence of stated features, regions, steps elements and/or components, but do not preclude the presence or addition of one or more other features, regions, integers, steps, operations, elements, components and/or groups thereof. As used herein, the conjunction “and” includes each of the structures, components, features, or the like, which are so conjoined, unless the context clearly indicates otherwise, and the conjunction “or” includes one or the others of the structures, components, features, or the like, which are so conjoined, singly and in any combination and number, unless the context clearly indicates otherwise. The term “or” is generally employed in its sense including “and/or” unless the content clearly dictates otherwise.

All numeric values are herein assumed to be modified by the term “about,” whether or not explicitly indicated. The term “about”, in the context of numeric values, generally refers to a range of numbers that one of skill in the art would consider equivalent to the recited value (i.e., having the same function or result). In many instances, the term “about” may include numbers that are rounded to the nearest significant figure. Other uses of the term “about” (i.e., in a context other than numeric values) may be assumed to have their ordinary and customary definition(s), as understood from and consistent with the context of the specification, unless otherwise specified. The recitation of numerical ranges by endpoints includes all numbers within that range, including the endpoints (e.g. 1 to 5 includes 1, 1.5, 2, 2.75, 3, 3.80, 4, and 5).

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

What is claimed is:

1. A pump for alternating tangential flow filtration comprising:
a diaphragm;
a housing containing the diaphragm, the housing having a first end open to a retentate channel of a first membrane;
a magnetic member coupled to the diaphragm; and
an electromagnetic field generator disposed about the magnetic member.

2. The pump for alternating tangential flow filtration of claim 1, wherein the magnetic member is overmolded within the diaphragm.

3. The pump for alternating tangential flow filtration of claim 1, further comprising an elongate member coupling the magnetic member to the diaphragm.

4. The pump for alternating tangential flow filtration of any of claims 1-3, wherein the housing further comprises a second end open to a 0.2 μm filter.

5. The pump for alternating tangential flow filtration of any of claims 1-2, wherein the housing further comprises a second end open to a retentate channel of a second membrane.

6. The pump for alternating tangential flow filtration of any of claims 1, 2, 4, 5, wherein the electromagnetic field generator is cylindrically disposed about the housing.

7. The pump for alternating tangential flow filtration of any of claims 1, 2, 4, 5, wherein the electromagnetic field generator is cylindrically disposed about the diaphragm.

8. The pump for alternating tangential flow filtration of any of claims 1-7, wherein the diaphragm further comprises a wall having a first thickness and the wall comprising at least one concentric ring comprising a second thickness different than the first thickness.

9. The pump for alternating tangential flow filtration of any of claims 1-8, wherein the diaphragm further comprises:
a perimeter portion comprising a first durometer;
a mid-portion comprising a second durometer less than the first durometer; and
a central portion comprising the first durometer;
wherein the mid-portion is overmolded between the perimeter portion and the central portion.

10. The pump for alternating tangential flow filtration of any of claims 1-9, wherein the diaphragm comprises a pre-formed sinusoid.

11. The pump for alternating tangential flow filtration of any of claims 1-9, wherein the diaphragm comprises a wall having a thickness tapering from a thicker central portion to a thinner perimeter portion.

12. The pump for alternating tangential flow filtration of any of claims 1-11, wherein the diaphragm further comprises a sensor in fluid communication with the retentate channel.

13. A pump for alternating tangential flow filtration comprising:
a diaphragm comprising a perimeter portion and a central portion;
a magnetic member disposed within the central portion of the diaphragm;
a housing containing the diaphragm, the housing having a first end open to a retentate channel of a first membrane; and
an electromagnetic field generator disposed about the housing, the electromagnetic field generator comprising an inner diameter substantially matching an outer diameter of the housing.

14. The pump for alternating tangential flow filtration of claim 13, wherein the magnetic member is overmolded within the diaphragm.

15. The pump for alternating tangential flow filtration of any claim of claims 13-14, further comprising a linear encoder along a height of the electromagnetic field generator.

16. The pump for alternating tangential flow filtration of any of claims 13-15, wherein the housing further comprises a second end open to a retentate channel of a second membrane.

17. The pump for alternating tangential flow filtration of any of claims 13-16, wherein the membrane is an alternating tangential flow membrane

18. A pump for alternating tangential flow filtration comprising:
a diaphragm comprising a perimeter portion and a central portion;
an elongate member having a first end coupled to the central portion of the diaphragm and a second end;
a magnetic member coupled to the second end of the elongate member;
a housing containing the diaphragm, the elongate member and the magnetic member, the housing comprising a first end open to a retentate channel of a membrane and a second end comprising a filter; and
an electromagnetic field generator reversibly containing the second end of the housing, the electromagnetic field generator comprising an inner diameter substantially matching an outer diameter of the second end of the housing.

19. The pump for alternating tangential flow filtration of claim 18, wherein the second end of the housing comprises an extension portion containing the magnetic member, the extension portion having a height substantially matching a height of a displacement of the diaphragm between a first position and a second position.

20. The pump for alternating tangential flow filtration of any of claims 18-19, wherein the membrane is an alternating tangential flow membrane.
